(19) United States
(12) Patent Application Publication
(10) Pub. No.: US 2009/0180541 A1
(43) Pub. Date: Jul. 16, 2009

(54) Video motion compensation

(76) Inventor: Zhiyong John Gao, Coventry (GB)

Correspondence Address: FLYNN THIEL BOUTELL & TANIS, P.C., 2026 RAMBLING ROAD, KALAMAZOO, MI, 49008-1631, US

(21) Appl. No.: 12/319,560

(22) Filed: Jan. 8, 2009

(30) Foreign Application Priority Data
Jan. 8, 2008 (GB) 0800277.6

(51) Int. Cl. H04N 7/26

(52) U.S. Cl. 375/240.16; 375/E07.104

(57) ABSTRACT

A method and apparatus are provided for video motion compensation suitable for use in decoding compressed video. An input buffer receives lines of blocks of video data and outputs lines of these to a first block transpose unit 52. This can selectively transpose the lines and columns of an input block of pixels. A vertical line filtering unit 58 is coupled to the block transpose unit for producing an output line of interpolated pixel samples. A first selector with inputs coupled to the output of the vertical line filtering unit and to the output of the input block transpose unit is able to select between an un-interpolated output line of pixels and an interpolated output line of pixel samples. A second selector 62 with inputs coupled to the outputs of the first block transpose unit and to the vertical line filtering unit is able to select between lines of pixels from the first input block transpose unit and from the vertical line filtering unit and provides these to a horizontal line filtering unit 66. The first and second selectors 60, 62 receive control signals related to motion vectors in an incoming stream of data.

### FIELD OF THE INVENTION

This invention relates to a method and apparatus for motion compensation in video data of the type which can provide multi-standard high definition video motion compensation using a reduced number of processors and memory.

### BACKGROUND OF THE INVENTION

In recent years digital video compression and decompression have been widely used in digital video related devices including digital TV, mobile phone, laptop and desktop computers, UMPC (ultra mobile PC), PMP (personal media players), PDA and DVD. In order to compress video, a number of video coding standards have been established, including H.263 by ITU (International Telecommunications Union), MPEG-2 and MPEG-4 by MPEG (Moving Picture Expert Group). The two latest video coding standards, H.264 by ITU and VC-1 by ISO/IEC (international Organization for Standardization/International Electrotechnical Commission), have been adopted as the video coding standards for next generation of high definition DVD, and HDTV in US, Europe and Japan. In addition AVS video coding standard has been developed and recently adopted as domestic video standard in China.

A picture compression is typically carried out by splitting a picture into many non-overlapping macroblocks and encoding each of those macroblocks sequentially. These macroblocks are, for example, 16 pixels by 16 pixels. In general each digital video picture is compressor encoded by removing redundancy in the temporal direction and the spatial direction (temporal being inter field and spatial being intra field).

The temporal redundancy reduction is performed by inter predictive encoding of the current picture in the forward and/or backward directions from a reference pictures. Motion estimation and predictive picture creation are performed on a macroblock basis from one or from several reference pictures. Macroblock compression is then carried out by coding the difference between a current macroblock and its predictive macroblock.

An inter-coded picture with only forward reference pictures is called a P-picture, and an inter-coded picture with both forward and backward reference pictures is called a B-picture. An inter-coded macroblock in a B-picture can refer to a random combination of forward and backward reference pictures. All reference pictures have to be encoded before they are used.

Spatial redundancy reduction is performed by intra field prediction without reference pictures. An intra predictive macroblock is created by interpolation of the pixels surrounding a current macroblock in a current picture. A picture with all intra-coded macroblocks is called an I-picture.

Motion compensation is used in the decoding of inter pictures including P-pictures and B-pictures. Motion compensation comprises creating predictive pixels with sub-pixel accuracy from reference frames based on the motion vectors in the streams and then adding the predictive pixels to the corresponding decoded pixel residuals to form decoded pixels.

Motion compensation is required in both a video encoder and a decoder as a video encoder has to include a local video decoder. As shown in FIG. 1. This shows a video motion compensation system. A video input is received by a multiframe buffer 2. This is capable of storing as many frames of data as are required by the video motion compensation system. Motion estimation takes place in a motion estimation unit 4. This compares pixels in macroblocks to determine the best appropriate motion vectors to be used for each macroblock. A motion compensation unit 6 is then used to determine predictive pixel values using the motion vectors. A subtractor 8 then provides a difference value between each predictive pixel and an actual pixel value at the same location as the predictive pixel by subtracting the predictive pixel from the actual pixel value. The actual pixel value is retrieved from the multiframe buffer 2. A motion vector encoding unit 10 and a pixel residual (difference) encoding unit 12 then encodes the motion vectors and pixel differences for each pixel and combines then in a single bitstream. The pixel residual local decoding unit decodes encoded pixel residuals locally and then the motion compensation units creates the predictive pixels and adds them to the decoded residuals to form decoded pixels. Finally the deblocking unit performs smooth filtering for each of 4×4 block edges in a current macroblock and then de-blocked pixels are sent back to multi-frame buffer 2 as the reference frames of the future inter frame encoding.

FIG. 2 shows a decoder for decoding data encoded by the system of FIG. 1. A motion vector decoding unit 20 and a pixel residual decoding unit 22 decode motion vectors and pixel residual information from an incoming bitstream. Previously decoded reference pictures (not shown) are also stored in a multi-frame buffer 24. The motion vectors and the reference picture data are then combined in a motion compensation unit 26 to derive a motion compensated version of each macroblock in turn. The result is combined with pixel residual data in an adder 28 to provide a better estimate of the current block. The result is sent to the multi-frame buffer 24 via a deblocker 30 to form a final decoded picture for playback and future reference from the multi-frame buffer 24.

In current international video coding standards, the biggest motion vector coverage is for a whole 16×16 macroblock and the smallest coverage is for a 4×4 block within a macroblock. When encoding high definition video, only the H.264 P-picture has a motion vector coverage area smaller than 8×8. The most complex motion compensation is in B-pictures as inter field prediction of each motion vector in a B-picture needs to be done up to twice, once from a forward reference picture and once from backward reference pictures.

The motion vectors in various video compression standards cover different block sizes. For example, MPEG-2 uses 16×16 and 16×8, VC-1, MPEG-4 and AVS use 16×16, 16×8 and 8×8, and H.264 uses 16×16, 16×8, 8×16, 8×8, 4×8, 8×4 and 4×4. Also, the smallest fractional pixel position in each of the video coding standards is different. For example, MPEG-2 is ½-pixel resolution, VC-1 is ¼-pixel and H.264 chroma is ⅛-pixel. Finally, different interpolation methods are used in each of the standards to obtain a predictive sample in a fractional pixel position from pixels in integer positions.

In MPEG-2 a bilinear filter is used to get samples in ½-pixel positions. In VC-1 a one or two dimensional 4-tap FIR (Finite Impulse Response filter) is used to get the fractional samples in both ½-pixel and ¼-pixel positions. As shown in FIG. 3, in H.264 a one or two dimensional 6-tap FIR is used to get the samples in ½-pixel positions (marked in dark grey), and as shown in FIG. 4 its ¼-pixel samples (marked in grey) are average of 2 nearest samples with at least one of those two samples being in ½-pixel position.

While two dimensional filtering is needed for sub-pixel sample interpolation, different coding standards have different filtering processing order. For example, in VC-1 vertical filtering needs to be done first followed by horizontal filtering, whereas in MPEG-4 ASP (Advanced Simple Profile) horizontal filtering has to be done first. Furthermore in H.264 either horizontal or vertical filtering can go first.

It is common in high definition video encoding/decoding that multiple engines are used to process more than one motion vector in parallel to meet the high speed demand of these systems. Also multi-standard video motion compensation requires a motion compensation engine to be highly programmable. Therefore there is a demand for a system which can efficiently perform sub-pixel motion compensation with a relatively simple implementation architecture.

Conventional motion compensation has two disadvantages. Firstly, multiple programmable interpolation engines dramatically increase the complexity of control with data flowing in the pipeline and SoC (system on chip) areas. Secondly, as the biggest motion vector covers a 16×16 block and the basic coding unit in video compression is a macroblock, the motion compensation needs to deal with a whole 16×16 macroblock so that its reference pixel fetch, input buffer, intermediate buffers and output buffer need to be able to store related data for a whole 16×16 macroblock.

### SUMMARY OF THE INVENTION

In accordance with one aspect of the present invention there is provided a video motion compensation system comprising:

an input buffer for providing output lines of pixels;

a first block transpose unit coupled to the input buffer for selectively transposing the lines and columns of an input block of pixels;

a vertical line filtering unit coupled to the first block transpose unit for producing an output line of interpolated pixel samples;

a first selector with inputs coupled to the output of the vertical line filtering unit and to the input block transpose unit to select between an uninterpolated output line of pixels and an interpolated output line of pixel samples;

a second selector with inputs coupled to the outputs of the first block transpose unit and the vertical line filtering unit to select between lines of pixels from the first input block transpose unit and lines of pixels from the vertical line filtering unit to be input to a horizontal line filtering unit;

a horizontal line filtering unit coupled to the selector for producing an output line of interpolated samples; and

wherein the first and second selectors receive control signals related to motion vectors in an incoming stream of data to cause each selector to select which input to connect to its output.

Further aspects of the invention are defined in the appended claims to which reference should now be made.

### BRIEF DESCRIPTION OF THE DRAWINGS

A preferred embodiment of the invention will now be described in detail by way of example with reference to the accompanying drawings in which:

FIG. 1 shows a motion compensation video encoder as described above;

FIG. 2 shows a motion compensation video decoder as described above;

FIGS. 3 and 4 show schematically the outputs of a 6-tap FIR filter for ½ pixel and % a pixel positions in H.264;

FIG. 5 shows a multi standard motion compensation system embodying the invention;

FIG. 6 shows a 2-dimensional sub-pixel line interpolation engine which may be used in the system of FIG. 5;

FIG. 7 shows an output from a H.264 motion compensation system for 8½ pixels samples;

FIGS. 8, 9 and 10 show different embodiments of the invention in a sub-pixel interpolation engine configured to deal with different H.264 ¼ pixel interpolation.

### DETAILED DESCRIPTION OF PREFERRED EMBODIMENTS

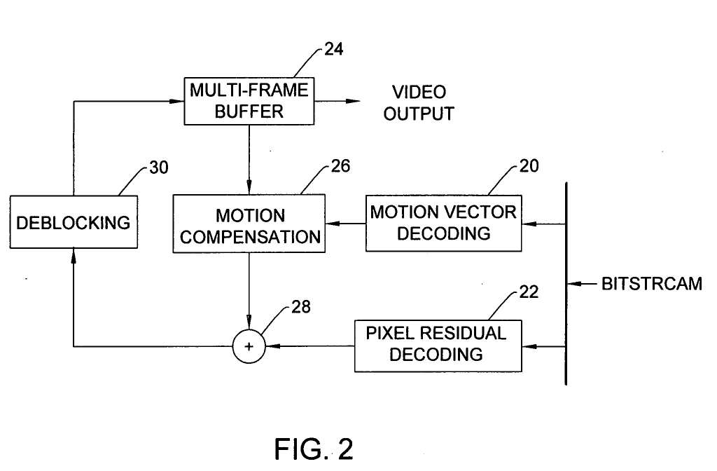

In order to implement motion compensation, motion vector related control information is required and it comes from the motion vector decoding unit 20 in FIG. 2. The information includes the size of each motion vector within a 16×16 macroblock and specifies the block size that the motion vector covers, the reference index of each motion vector, the reference picture number corresponding to each motion vector, horizontal and vertical component values of each motion vector with up to ¼-pixel accuracy, the location of the reference pixels in the reference picture and whether sub-pixel interpolation is needed. When a motion vector has fractional horizontal or vertical component value, its motion compensation requires horizontal or vertical interpolation. When a motion vector has fractional horizontal and vertical component values, its motion compensation requires both horizontal and vertical interpolations. For different fractional motion vector component values, the motion compensation unit implements different sub-pixel interpolation processes as defined in different video compression standards.

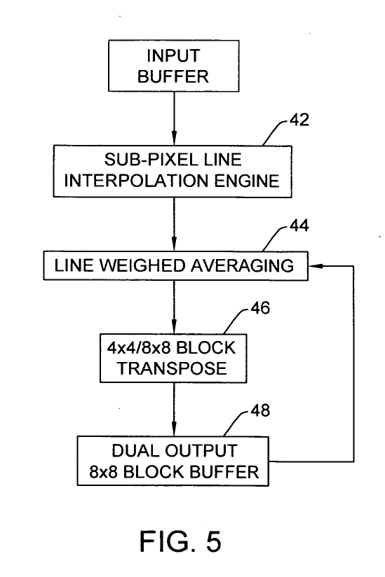

In FIG. 5 there is shown a multi-standard motion compensation pipeline. This comprises an input buffer 40, coupled to a sub-pixel line interpolation engine 42. The output of this is connected to a line weighted averaging unit 44 and then to a block transpose unit 46 before being provided to an output block buffer 48. There is a feedback loop from the output block buffer to the line weighted averaging unit block in case the output needs to be weighted averaged with a later input block.

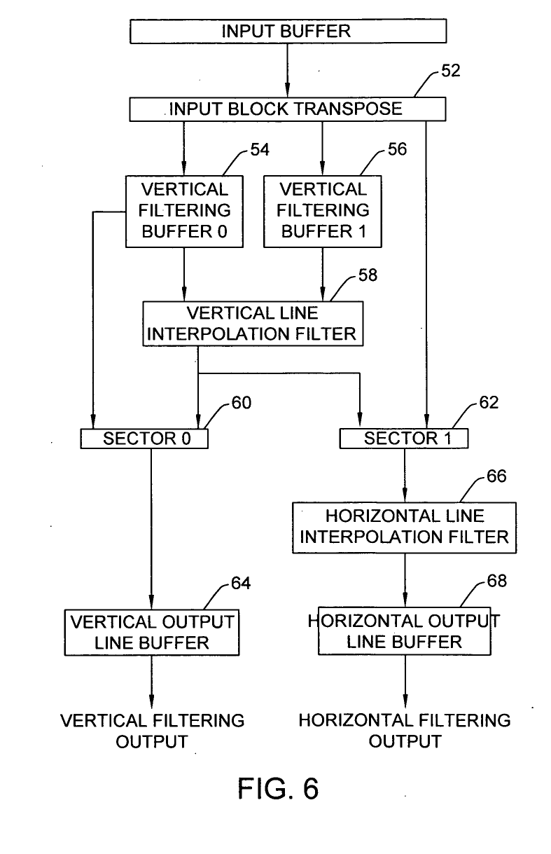

A detailed block diagram of the sub-pixel interpolation engine is given in FIG. 6. This has an input buffer 50 and an input block transpose unit 52. The input block transpose unit can transpose rows of an input block of pixels to columns and vice versa, or can supply rows and columns of pixels un-transposed

Connected to the input block transpose unit 52 are first and second vertical filtering buffers 54 and 56. These are used to store the same pixels in each filtering buffer and may output different lines of pixels for subsequent vertical interpolation in a vertical line interpolation unit 58 to which they are both coupled.

First and second selector units 60 and 62 are connected to the output of the vertical line interpolation unit. Each one receives control signals from an external motion vector decoder 20 that decodes all motion vectors from an incoming bitstream to select one of its two inputs as its output.

The motion vector decoder 20 determines the control signals to apply to a selector unit 60 and 62 from the motion vector. As stated above, this includes the size of each motion vector and the block it covers, a reference index for each motion vector specifying the reference picture number to which it applies, horizontal and vertical component values for each motion vector that specify the location of the reference pixels and the reference picture and determine whether or not sub pixel interpolation is needed. When a motion vector has fractional horizontal or vertical component values, its motion compensation requires horizontal or vertical interpolation and the control signals are applied to units 60 and 62 accordingly. When it has both fractional horizontal and vertical component values both horizontal and vertical interpolations are required as appropriate control signals are applied to selecting 60 and 62. The precise arrangement of interpolators which arises from the application of these control signals will be apparent from the examples of different interpolation schemes which are described below in this specification.

As horizontal/vertical sub-pixel filtering is needed only if the motion vector has a fractional horizontal/vertical component, the motion vector decoder generates the different selection signals based on the fractional values of two components. The selector unit 60 is used to select whether the vertical line interpolation 58 is needed or not. The selector unit 62 is used to select the input data of a horizontal interpolation unit 66 from two possible sources, input block transpose unit 52 and vertical interpolation unit 58. Using the selector the engine can be configured to operate in horizontal, vertical, and a number of different 2 dimensional interpolation modes. The horizontal line interpolation unit can accommodate a number of pixels in corresponding vertical positions on a horizontal line and can interpolate between them. The result is provided to a horizontal line output buffer 68.

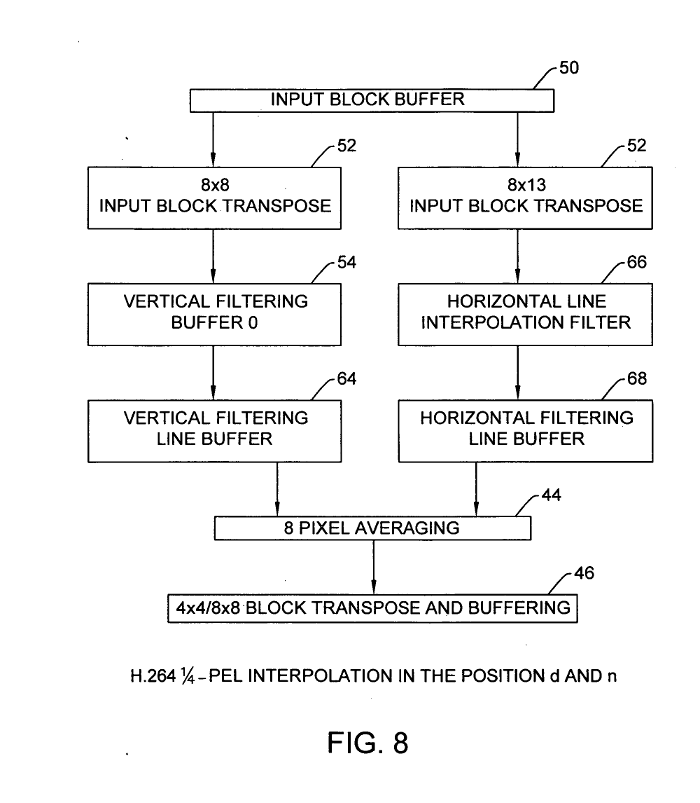

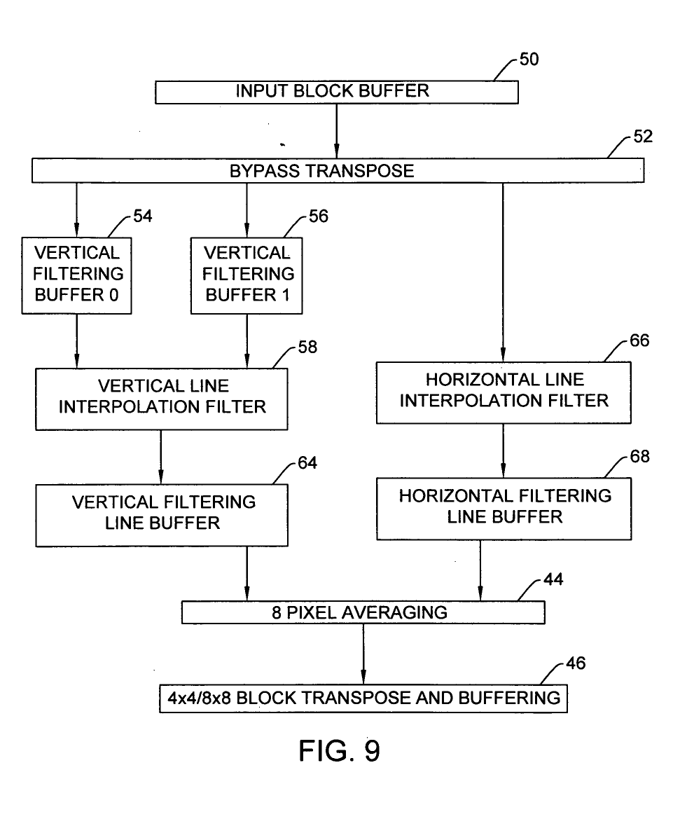

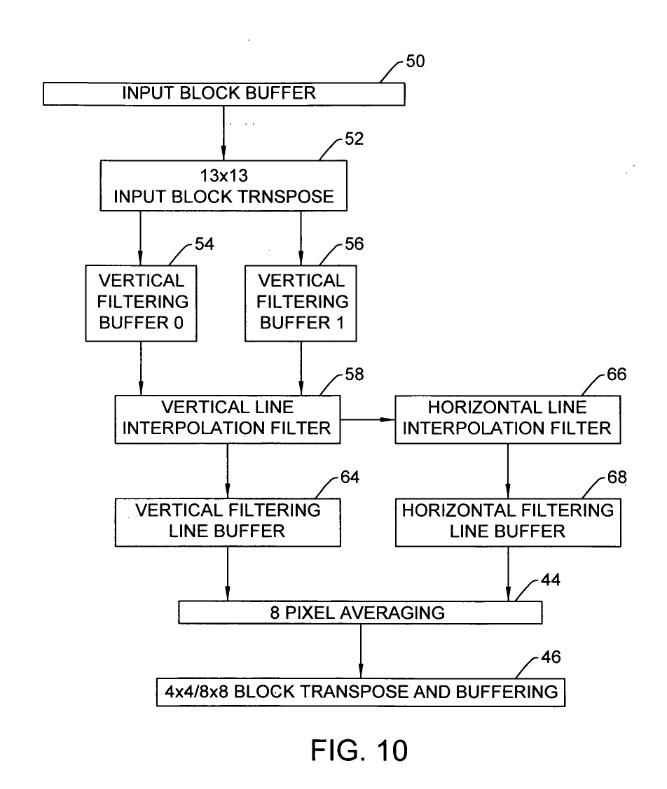

FIG. 8, FIG. 9 and FIG. 10 are examples of the sub-pixel interpolation pipeline configured in different modes to deal with different H.264 ¼-pixel interpolations.

The apparatus in this example can be configured to one of two basic motion compensation modes: 8×8 or 4×4 motion vector mode although others may be used with appropriate modification. A motion vector that covers a block of more than 8×8 pixels, is processed sequentially as two or four 8×8 motion vectors with the same value. Similarly an 8×4 or 4×8 motion vector is processed as two 4×4 motion vectors sequentially.

The vertical line interpolation filter 58 and horizontal line interpolation filter 66 can be configured to either run in parallel or in serial where vertical line filtering is performed first followed by the horizontal line filtering. The parallel mode can be used to create up to two lines of sub-pixel samples, one only needs horizontal filtering and the other only needs vertical filtering. With an input transpose unit the serial mode can be used to create up to two lines of sub-pixel samples, one needs 2-dimensional filtering and the other only needs 1-dimensional filtering.

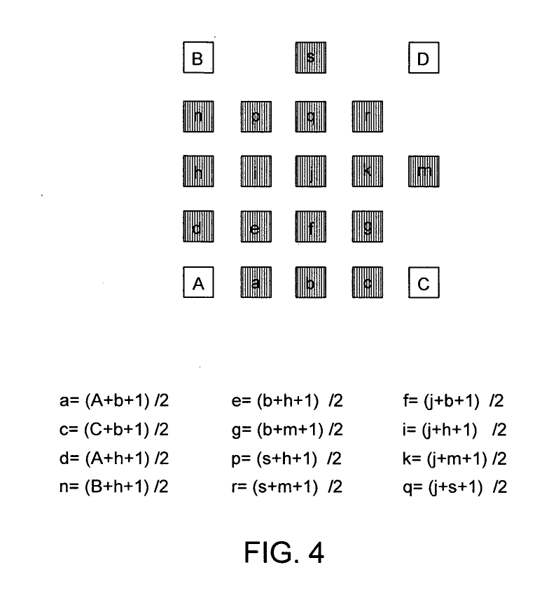

From FIG. 4, depending on different positions the H.264 ¼-pixel interpolation may need up to two ½-pixel samples, one with 2-dimensional filtering and another one with only 1-dimensional filtering. If the line of samples with 1-dimensional filtering can be created based on the middle result of 2-dimensional filtering, two lines of required ½-pixel samples can be created by only using the 2-dimensional filtering once. As a result the processing time of ¼-pixel interpolation will be halved.

The apparatus gives three benefits. Firstly, it reduces the sizes of the processing related buffers from the 16×16 macroblock level to an 8×8 block level as the pipeline works on the basis of an 8×8 or 4×4 motion vector. Secondly, it removes the requirement for simultaneously processing multiple motion vectors as it only processes each one of an 8×8 or 4×4 motion vector sequentially. Thirdly, either the horizontal line interpolation filter or the vertical line interpolation filter is in fact a simple pixel line filter that only consists of a line of MAC (Multiplier-Accumulators) with programmable tap values, which outputs a line of interpolated sub-pixel samples each time.

There are a number of reasons why the line processor can go fast, in particular fast enough for most complicated H.264 sub-pixel sample interpolation in HD video compression and decompression. Firstly, with the use of an input block transpose unit the filtering pipeline can be configured so that any two lines of samples in ½-pixel positions required by a line of H.264 ¼-pixel samples can be derived concurrently by only using the line interpolation pipeline once. One line of ½-pixel samples with 1 dimensional filtering can be derived from vertical line interpolation unit 58 while another line of ½-pixel samples with horizontal filtering only or 2-dimensional filtering can be derived from horizontal line interpolation unit 66 because the line of ½-pixel samples with 2-dimensional filtering can share the vertical dimensional filtering result with the line of ½-pixel samples with vertical filtering only.

As a result, any single line of 8 or 4 sub-pixel samples within an 8×8 or 4×4 motion vector in MPEG-2, VC-1 and H.264 can also be interpolated by using the line interpolation pipeline once.

Secondly, either the vertical line interpolation filter or the horizontal line interpolation filter can be configured so that any FIR interpolation with evenly symmetric taps can be implemented by half of its taps. For vertical line interpolation, the two input buffer units 54 and 56 can send two lines of pixels with the same taps. A line of adders inside the vertical interpolation unit adds two pixels in the same horizontal position together first and then multiplies by the tap values. For horizontal interpolation, there are two groups of internal line shift buffers and by a line of adders to add two different pixels in the same line together and then multiply the tap values.

With those above two advantages, H.264 ½-pixel interpolation processing time is halved and the most complicated H.264 ¼-pixel interpolation time is only one-fourth of the time take using a conventional approach.

Thirdly there is no time delay between two motion vectors being processed except for a line delay which is needed in H.264, while both line filters are required sequentially by a first motion vector and are then required concurrently by a second motion vector, because the horizontal line filter is one line behind the vertical line interpolation filter in sequential operation mode.

The input block transpose unit plays two roles. Firstly, it is used to transpose an input pixel block so that two different filtering orders, horizontal first and vertical first, can be realized without changing the internal filtering pipeline order. More importantly, the transpose unit also is used in H.264 ¼-pixel interpolation on the basis of an 8×8 or 4×4 motion vector to obtain two ½-pixel pixel lines with only a single pipeline flow.

Furthermore, the line averaging unit 44 in FIG. 5 can be configured to give weighted averaging predictive blocks of forward and backward predictive blocks in B-picture, or to get a line of 8 or 4 samples in ¼-pixel positions in the H.264 standard.

In the following examples, different H.264 ¼-pixel interpolation processes which can be interpolated using the system of FIGS. 5 and 6 are shown as they are the most complicated cases in multi-standard motion compensation.

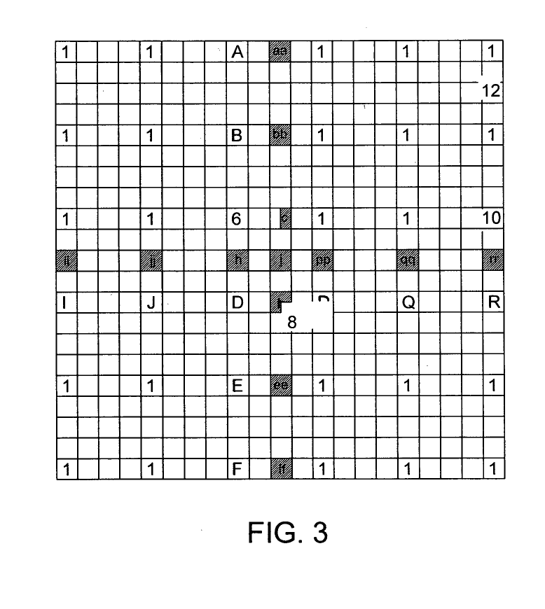

According to FIG. 3, there are 3 different situations where we need to obtain samples in ½-pixel positions. For a ½-pixel sample b which is only horizontally in a sub-pixel position, a 6-tap horizontal FIR is used with the nearest 6 pixels as follows,

b₁=I−5*J+20*D+20*P−5*Q+R

b=(b₁+16)/32

For the ½-pixel sample h which is only vertically in a sub-pixel position, a 6-tap vertical FIR is used with the nearest 6 pixels as follows,

h₁=Λ−5*B+20*C+20*D−5*E+F

h=(h₁+16)/32

For the ½-pixel sample j which is horizontally and vertically in a ½-pixel position, a 2-dimensional 6-tap FIR with either horizontal filtering first or vertical filtering first,

j₁=ii₁−5*jj₁+20*h₁+20*ppᵢ−5*qq₁+rr₁ or

j₁=aa₁−5*bb₁+20*cc₁+20*b₁−5*ee₁+ff₁

j=(j₁+512)/1024

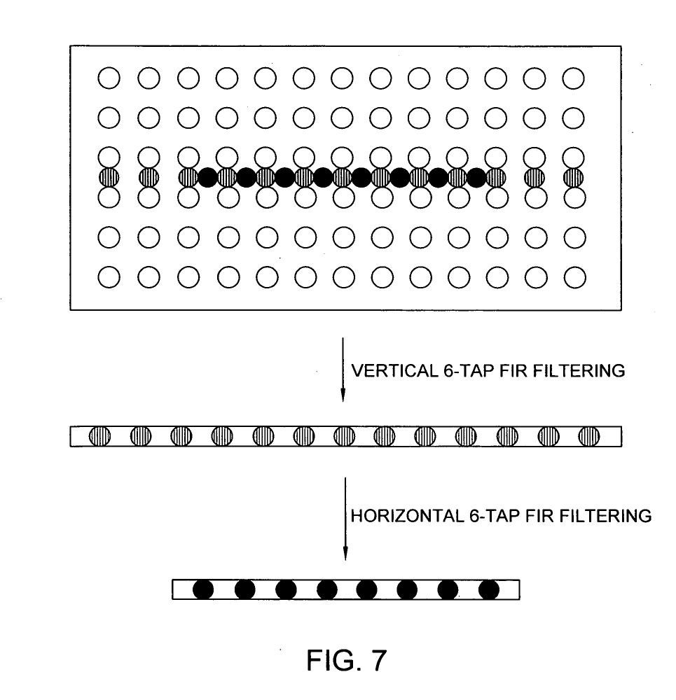

FIG. 7 shows how a line of 8 sub-pixel samples in position j, is derived by a 2-dimensional filtering pipeline. The 13×6 input pixel block is input to a vertical line filter 58 to get a line of 13 samples in vertical ½-pixel positions, the line of samples then passes through the horizontal line filter 66 to give a final line of 8 samples both horizontally and vertically in ½-pixel positions.

In FIG. 4, there are 3 different situations for obtaining the samples in ¼-pixel positions. The ¼-pixel samples a and c are only horizontally in sub-pixel positions, so they are derived from a nearest pixel and a ½-pixel sample b. Therefore they require 6-tap horizontal filtering only.

a=(A+b+1)/2

c=(C+b+1)/2

The ¼-pixel samples d and n are only vertically in a sub-pixel position, so they are derived from a nearest pixel and a ½-pixel sample h. Therefore they require 6-tap vertical filtering only.

d=(A+h+1)/2

n=(B+h+1)/2

The samples e, g, p and r are both horizontally and vertically in ¼-pixel positions: they are derived from the two nearest ½-pixel samples, one needs 6-tap horizontal filtering only and another needs 6-tap vertical filtering only as follows

e=(b+h+1)/2

g=(b+m+1)/2

p=(s+h+1)/2

r=(s+m+1)/2

The samples f, i, k and q have one dimension in ¼-pixel positions and another dimension in a ½-pixel position: They are derived from the two nearest ½-pixel samples, one is j that needs 2 dimensional 6-tap filtering and another needs either horizontal or vertical 6-tap filtering only as follows

f=(j+b+1)/2

i=(j+h+1)/2

k=(j+m+1)/2

q=(j+s+1)/2

The most complex case is to obtain ¼-pixel sample f, i, k and q as it requires two ½-pixel samples including sample j. To get each of them, a different filtering order is needed to get j so that another ½-pixel can be derived from a first vertical filtering. The input block transpose unit 52 is used to obtain the correct j filtering order. For example, for sample f the filtering order is horizontal first as ½-pixel sample b also is needed, and for sample i the filtering order is vertical first as a ½-pixel sample h is also needed.

FIG. 8 shows how a line of 8 sub-pixel samples in position d or n is derived in the line filtering engine. This is an example of the configurable sub-pixel interpolation system of FIG. 6 in which the selector 0 60 selects the vertical filtering buffer 54 and the selector 1 62 selects input block transpose unit 52. In this case only a ½-pixel sample with 1-dimensional filtering and a pixel in integer position are needed to get a final ¼-pixel sample. To change vertical filtering to horizontal filtering, the 8×13 input pixel block is transposed to a 13×8 block and input to the horizontal line interpolation filter line by line. Also an 8×8 pixel block in position A or B is transposed and sent to vertical buffer for the final line averaging processing.

In FIG. 8, the lines from input block buffer 50 are passed through the input block transposing unit 52 to perform a 8×8 block transpose first with lines being provided to vertical filtering buffer 54 before they are directly sent to vertical filtering line buffer 58 without vertical filtering. At the same time, input block transpose unit 52 transposes an 8×13 block and provides it line by line to horizontal line interpolation filter 66 and then to the horizontal filtering line buffer 68 before also providing this to the 8 pixel averaging unit 44. Pixels are then reconfigured to the correct positions using the block transpose and buffering unit 46.

FIG. 9 shows how a line of 8 sub-pixel samples in position e, g, p or r is derived in the filtering engine. It is an example of the configurable sub-pixel interpolation system of FIG. 6 in which the both selector 0 60 and select 1 62 select the output of vertical interpolation filter 58. In this case, two ½-pixel samples with only 1-dimensional filtering are needed to get a final ¼-pixel sample. The engine is configured for vertical and horizontal parallel filtering mode without an input block being transposed so that two required lines of ½-pixel samples can be derived concurrently. Of the 13×13 input pixel block required by an 8×8 sub-pixel motion vector, an 8×6 block is input to the vertical line interpolation filter to get a line of 8 samples in vertically ½-pixel positions. Meanwhile a line of 13 pixels is input to the horizontal line filter to get 8 samples in horizontal ½-pixel positions. Then a line of 8¼-pixel samples is derived from the line averaging unit. Line by line, finally an 8×8 sub-pixel sample block is derived from line averaging unit.

Pixels from the input block buffer 50 are passed straight through the block transpose unit 52 to vertical filtering buffer 54 and vertical filtering buffer 56. Data from these two filtering buffers passes to vertical line interpolation filter 58 and then to vertical filtering line buffer 64. At the same time data passes straight through to the horizontal line interpolation filter 66 and then to the horizontal filtering line buffer 68. The vertical filtering line buffer 64 and the horizontal filtering line buffer 68 provide the inputs to a pixel averaging unit 44 whose output is provided to a block transpose and buffering unit 46 for reconfiguration to the correct positions.

FIG. 10 shows how a line of 8 sub-pixel samples in position f, i, k or q is derived in the filtering engine. It is an example of the configurable sub-pixel interpolation system of FIG. 6 in which both selector 060 and selector 1 62 select the output of vertical interpolation filter 58. In this case, two ½-pixel samples are needed to get a final ¼-pixel sample, one with only 1-dimensional filtering and another with 2-dimensional filtering. The engine is configured for vertical and horizontal sequentially filtering mode with input block transpose so that 2 required lines of ½-pixel samples can be derived concurrently. For example, the ¼-pixel sample line in position f needs to have a line of samples in ½-pixel position j and a line of samples in ½-pixel position b. In order to ensure the vertical filter outputs a line of samples in b and then horizontal filter outputs a line of samples in j, the horizontal filtering has to be done first so that the 1 3×13 input block has to be transposed as b only needs horizontal filtering. For the ¼-pixel sample line in position i, input block transpose is not needed as it requires a line of ½-pixel samples in h and a line of ½-pixel samples in j, so vertical filtering has to be done first.

Pixels from input block buffer 50 are transposed in a 13×13 block in input block transpose unit 52 are fed to vertical filtering buffers 54 and 56. These both provide inputs to vertical line interpolation filter 58 whose output is provided to horizontal line interpolation filter 56 as well as to vertical filtering line buffer 64. The output of the horizontal line interpolation filter 66 is provided to the horizontal filtering line buffer 68.

The outputs of the vertical filtering line buffer 64 and horizontal filtering line buffer 68 are provided to 8 pixel averaging unit 44 which provides output pixels to the block transpose and buffering unit 46 for reconfiguration to the correct pixel positions.

For H.264 luma, if 1-tap processing can be done in one cycle the apparatus can process an 8×8 motion vector within 24 cycles, and a 4×4 motion vector within 12 cycles as its 6-tap is halved to 3-taps.

For VC-1 luma, if 1-tap processing can be done in one cycle the apparatus can process an 8×8 motion vector within 16 cycles as its ½-pixel interpolation requires 4-tap symmetric FIR, and process an 8×8 motion vector within 32 cycles as its ¼-pixel interpolation requires 4-tap asymmetric FIR.

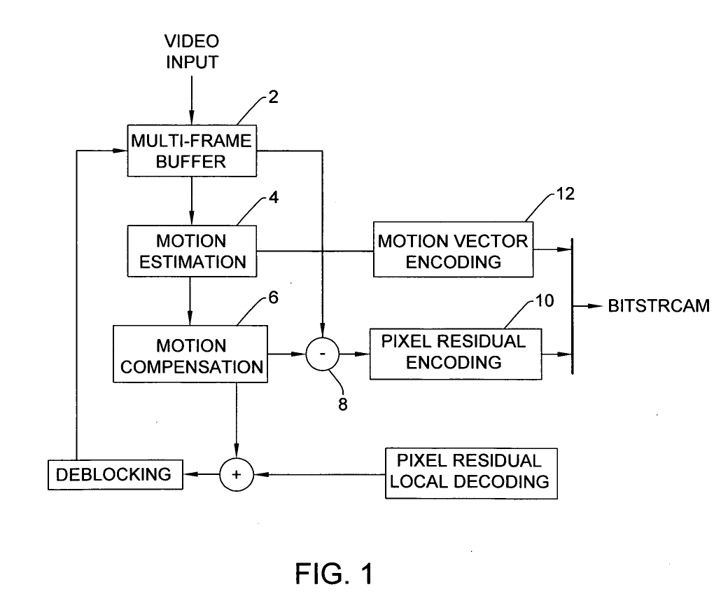

The system is operable to encode video data for subsequent transmission by using it as a motion compensation unit in the arrangement of FIG. 1. It may also be used as the motion compensation unit in a decoder of the type shown in FIG. 2 which may be incorporated in a receiver. Both encoder and decoder may therefore have their performance improved.

Although embodiments of the invention have been described with reference to particular compression standards for video data, the system may be modified for use with other standards and block sizes in a manner, which will be apparent to those skilled in the art.

1. A video motion compensation system comprising:
an input buffer for providing output lines of pixels;
a first block transpose unit coupled to the input buffer for selectively transposing the lines and columns of an input block of pixels;
a vertical line filtering unit coupled to the first block transpose unit for producing an output line of interpolated pixel samples;
a first selector with inputs coupled to the output of the vertical line filtering unit and to the output of the input block transpose unit to select between an uninterpolated output line of pixels and an interpolated output line of pixel samples;
a second selector with inputs coupled to the outputs of the first block transpose unit and the vertical line filtering unit to select between lines of pixels from the first input block transpose unit and lines of pixels from the vertical line filtering unit to be input to a horizontal line filtering unit;
a horizontal line filtering unit coupled to the selector for producing an output line of interpolated samples; and
wherein the first and second selectors receive control signals related to motion vectors in an incoming stream of data to cause each selector to select which input to connect to its output.

2. A video motion compensation system according to claim 1 for use in a video compression system.

3. A video motion compensation system according to claim 1 including a pair of parallel input buffers coupled between the input block transpose unit and the vertical line filtering unit.

4. A video motion compensation system according to claim 1 wherein the vertical line interpolation filter and the horizontal line interpolation filter operate concurrently.

5. A video motion compensation system according to claim 1 in which the outputs of the first selector and the horizontal line interpolation filter are coupled to a line weighted averaging unit.

6. A video motion compensation system according to claim 5 in which the output of the line weighted averaging unit is coupled to an output block transpose unit for selectively transposing an output line of pixels.

7. A video motion compensation system according to claim 1 which derives output pixels to subpixel accuracy.

8. A video motion compensation system according to claim 1 for use with the H264 coding standard.

9. A video motion compensation system according to claim 1 for use with the VC-1 coding standard.

10. A video motion compensation system according to claim 1 for use with the MPEG coding standard.

11. A video motion compensation system according to claim 1 for use with the AVS coding standard.

12. A video motion compensation system according to claim 1 wherein the local decoding unit derives control signals from the size of a motion vector and the block size that it covers.

13. A video motion compensation system according to claim 1 in which the local decoding unit derives control signals from a reference index for each motion vector.

14. A video motion compensation system according to claim 1 in which the local decoding unit derives control signals from horizontal and vertical components of each motion vector.

15. A method for video motion compensation comprising the steps of buffering input lines of pixels;
selectively transposing lines and columns of an input block of pixels;
vertically line filtering a line of pixels provided by the transposing step to produce an output line of interpolated pixel samples;
selecting between interpolated and un-interpolated pixel samples to provide a vertically filtered output;
horizontally filtering an output from the vertical filtering step or from the transposing step to provide a horizontal filtering output; and wherein
the selecting steps are dependent upon control signals related to motion vectors in an incoming stream of data.
